(19) United States
(12) Patent Application Publication
(10) Pub. No.: US 2022/0170168 A1
(43) Pub. Date: Jun. 2, 2022

(54) HIGH-PERFORMANCE ELECTRODE FOR WATER ELECTROLYSIS USING ELECTROSPRAY, MEMBRANE ELECTRODE ASSEMBLY INCLUDING THE SAME, WATER ELECTROLYSIS DEVICE INCLUDING THE SAME, AND MANUFACTURING METHOD THEREOF

(71) Applicant: KOREA INSTITUTE OF SCIENCE AND TECHNOLOGY, Seoul (KR)

(72) Inventors: Han Ik JO, Seoul (KR); Hee-Young PARK, Seoul (KR); Jong Hyun JANG, Seoul (KR); Hyun S. PARK, Seoul (KR); Bora SEO, Seoul (KR); Hyoung-Juhn KIM, Seoul (KR); Sung Jong YOO, Seoul (KR)

(21) Appl. No.: 17/537,209

(22) Filed: Nov. 29, 2021

(30) Foreign Application Priority Data
Nov. 30, 2020 (KR) 10-2020-0163770

(51) Int. Cl. C25B 11/052; C25B 1/04; C25B 11/081

(52) U.S. Cl. CPC C25B 11/052; C25B 11/081; C25B 1/04

(57) ABSTRACT

The present disclosure provides a high-performance electrode for water electrolysis using electrospray, a membrane electrode assembly including the same, a water electrolysis device including the electrode for water electrolysis, and a method for manufacturing the electrode for water electrolysis. The present disclosure is to provide a membrane electrode assembly (MEA) having increased porosity by using electrospray, and to apply the membrane electrode assembly to electrolysis.

### CROSS-REFERENCE TO RELATED APPLICATION

This application claims the priority of Korean Patent Application No. 10-to 2020-0163770 filed on Nov. 30, 2020, and all the benefits accruing therefrom under 35 U.S.C. § 119. the contents of which in its entirety are herein incorporated by reference.

### TECHNICAL FIELD

This invention was made with the support of the ministry of Science and ICT under Project No.1711108085, which was conducted under the research project entitled “Development of membrane electrode assembly and stack for polymer electrolyte membrane (PEM) water electrolyzer” within the project named “Project for Development of Innovative Technology in Hydrogen Energy” under the management of the National Research Foundation of Korea, from Mar. 1, 2020 to Dec. 31, 2020.

This invention was made with the support of the ministry of Science and ICT under Project No. 1711096817, which was conducted under the research project entitled “Development of innovative technologies for low-cost and durable low-Pt electrocatalysts and electrodes for PEMFO MEAS” within the project named “Project for Development of Basic Source Technology to cope with the climate change” under the management of the National Research Foundation of Korea, from Jun. 19, 2019 to Apr. 18, 2020.

The present disclosure relates to an electrode for water electrolysis, including a substrate: and a catalyst layer formed on the substrate through electrospray, a membrane electrode assembly including the same, a water electrolysis device including the electrode for water electrolysis, and a method for manufacturing the electrode for water electrolysis.

### BACKGROUND ART

New and renewable energy, such as solar light, wind power generation, or the like, has been spotlighted as future energy substituting for the existing fossil fuel, as climate change has become a serious problem. Electricity generated as new and renewable energy is intermittent, and thus is required to be stored as one type of fuel. In this context, hydrogen is the most prominent substitute fuel candidate.

Meanwhile, in the case of water electrolysis used as technology for producing hydrogen fuel, hydrogen and oxygen can be produced through water electrolysis. In the case of a fuel cell, it can generate electricity by using hydrogen and oxygen fuel. In addition, intensive studies have been conducted about fuel cells to such a degree that fuel cells are applied to vehicles and hydrogen fueled cars are commercialized.

However, the current water electrolysis devices require an excessive amount of noble metal catalyst for manufacturing electrodes, resulting in significantly high system costs. Therefore, there is a need for developing a water electrolysis device including a catalyst layer capable of easy internal transport of reactants and removal of products, while using a reduced loading amount of noble metal.

### DISCLOSURE

### Technical Problem

A technical problem to be solved by the present disclosure is to provide a membrane electrode assembly (MEA) having increased porosity by using electrospray, and to apply the membrane electrode assembly to electrolysis.

### Technical Solution

In one general aspect, there is provided an electrode for water electrolysis, including: a substrate; and a catalyst layer formed on the substrate through electrospray.

In still another general aspect, there is provided a membrane electrode assembly for water electrolysis, including the electrode for water electrolysis.

In still another general aspect, there is provided a water electrolysis device including the electrode for water electrolysis.

In yet another general aspect, there is provided a method for manufacturing the electrode for water electrolysis, including the steps of: preparing a substrate; and forming a catalyst layer on the substrate through electrospray.

### Advantageous Effects

According to the embodiments of the present disclosure, the electrode for water electrolysis or the membrane electrode assembly including the same show higher performance as compared to the water electrolysis reported according to the related art. In addition, catalyst coating using an electrospray process can provide an increased interval between particles through the repulsion caused by electric charging of catalyst particles, resulting in improvement of porosity.

### BRIEF DESCRIPTION OF DRAWINGS

FIG. 1 illustrates the electrolysis performance of the water electrolysis according to an embodiment of the present disclosure.

FIG. 2A is a schematic view illustrating the catalyst coating using electrospray according to an embodiment of the present disclosure.

FIG. 2B is a schematic view illustrating the catalyst coating using the conventional physical spray.

FIG. 3 and FIG. 4 illustrate the thickness of an electrode depending on ionomer content according to an embodiment of the present disclosure.

FIGS. 5A and 5B illustrates the water electrolysis performance according to an embodiment of the present disclosure.

FIG. 6 illustrates the pore volume of an electrode catalyst layer depending on ionomer content according to an embodiment of the present disclosure.

### Best Mode

Exemplary embodiments now will be described more fully hereinafter with reference to the accompanying drawings.

The following exemplary embodiments are for illustrative purposes only. This disclosure may, however, be embodied in many different forms and should not be construed as limited to the exemplary embodiments set forth therein.

It should be understood that since various modifications may be made to this disclosure and this disclosure may be embodied in different forms, the description proposed herein is just a preferable example for the purpose of illustrations only, not intended to limit the scope of the disclosure, and other changes, equivalents and modifications within the scope of the disclosure will become apparent to those skilled in the art from this detailed description.

Throughout the specification, the expression “a part comprises an element” does not preclude the presence of any additional elements but means that the part may further comprise the other elements, unless otherwise stated.

In one aspect, there is provided an electrode for water electrolysis, including: a substrate; and a catalyst layer formed on the substrate through electrospray.

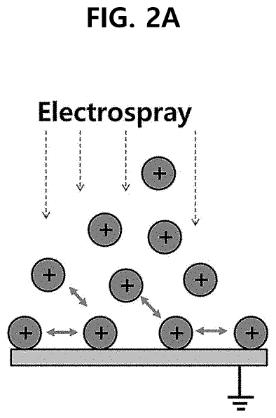

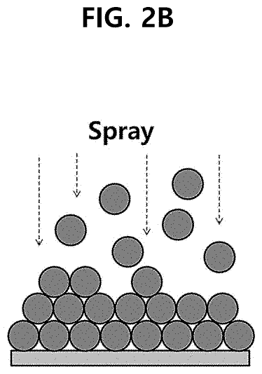

Referring to FIG. 2A, catalyst coating using an electrospray process can provide an increased interval between particles through the repulsion caused by electric charging of catalyst particles, resulting in improvement of porosity. On the contrary, referring to FIG. 2B, the conventional physical spray process provides a catalyst layer coated more densely, and thus makes it difficult to carry out internal transport of reactants and removal of products, resulting in a significantly large difference in current density particularly at a high voltage.

According to an embodiment of the present disclosure, the catalyst layer may have a porosity of 5-20%. For example, the catalyst layer may have a porosity of 5% or more, 6% or more, 7% or more, or 8% or more, and 20% or less, 15% or less, 10% or less, or 9% or less.

According to an embodiment of the present disclosure, the electrode may be an anode, and the catalyst layer may include a metal catalyst, a metal oxide, a metal sulfide, a metal phosphide, and any supported catalyst including a carrier (carbon, oxide, a combination thereof, etc.) containing the same. For example, the electrode may include a platinum-based oxide (iridium oxide (IrO₂), ruthenium oxide), a platinum catalyst supported on a carrier containing carbon, or at least one selected from the group consisting of the above-mentioned catalysts, or at least one of iridium oxide (IrO₂), ruthenium oxide and a carbon-supported platinum catalyst, preferably IrO₂.

According to an embodiment of the present disclosure, when the electrode is an anode, the catalyst layer may have a catalyst loading amount of 0.5-1.5 mg/cm².

According to an embodiment of the present disclosure, the electrode may be a cathode, and the catalyst layer may include a metal catalyst, a metal oxide, a metal sulfide, a metal phosphide, and any supported catalyst including a carrier (carbon, oxide, a combination thereof, etc.) containing the same. For example, the catalyst layer may include at least one selected from the group consisting of an alloy (Ni, Co, Cr) based on a carbon-supported platinum catalyst, non-noble metal catalyst (Ni, Co, Cr, Mn), sulfide, nitride, phosphide and a heteroatom-doped carbon material, or at least one selected from the group consisting of iridium oxide (IrO₂), ruthenium oxide and a carbon-supported platinum catalyst, preferably Pt/C.

According to an embodiment of the present disclosure, when the electrode is a cathode, the catalyst layer may have a catalyst loading amount of 0.3-1.3 mg/cm².

According to an embodiment of the present disclosure, the catalyst layer may further include an ionomer. For example, the catalyst layer may consist of a catalyst and ionomer dispersed therein and may be sprayed on the substrate. According to a particular embodiment of the present disclosure, the ionomer may be a cation-conducting ionorner and an anion-conducting ionomer, such as Nafion or Aquivion.

In another aspect, there is provided a membrane electrode assembly for water electrolysis, including the electrode for water electrolysis.

In still another aspect, there is provided a water electrolysis device including the electrode for water electrolysis.

In yet another aspect, there is provided a method for manufacturing the electrode for water electrolysis, including the steps of: preparing a substrate; and forming a catalyst layer on the substrate through electrospray.

According to an embodiment of the present disclosure, the electrospray may be carried out at a voltage of 15-25 kV.

According to an embodiment of the present disclosure, the step of forming a catalyst layer on the substrate through electrospray may be carried out by spraying a solution containing a catalyst, solvent and an ionomer through an electrospray process.

According to an embodiment of the present disclosure, the content of the ionomer may be 5-30 wt % based on the total weight of the solution. For example, the content of the ionomer may be 5 wt % or more, 7 wt % or more, 9 wt % or more, 11 wt % or more, 12 wt % or more, or 13 wt % or more, and 30 wt % or less, 25 wt % or less, 20 wt % or less, 15 wt % or less, 14 wt % or less, or 13 wt % or less, based on the total weight of the solution.

Exemplary embodiments now will be described more fully hereinafter. The present disclosure may, however, be embodied in many different forms and should not be construed as limited to the exemplary embodiments set forth therein.

### EXAMPLES

### Example 1: Manufacture of Electrode for Water Electrolysis

Each of the solution for an anode and the solution for a cathode was prepared according to the composition as shown in the following Table 1, and each solution was sprayed through an electrospray process. As an ionomer, a commercially available product, Nafion, was used. Particularly. ESR200RD available from NanoNC Co. was used. In addition, the electrospray process was carried out under the following conditions.

### Electrospray Conditions

Voltage applied between electrospray tip and current collector: 20 kV
Interval between tip and current collector: 7 cm
Catalyst solution feed flow rate: 20 μL/min
Humidity 39.1%

TABLE 1
Preparation of slurry

| Anode | | Cathode | | |
|---|---|---|---|---|
| Materials | Amounts (g) | Materials | Amounts (g) | |
| IrO₂ | 0.1 | Pt/C (46.6% TKK) | 0.1 | (0.0466 g) |
| Deionized Water | 0.6 | D.I. Water | 0.6 | |
| Ionomer | 0.5 (20 wt %) | Ionomer | 0.4 | (30 wt %) |
| (5% solution) | | (5% solution) | | |

| | | | |
|---|---|---|---|
| IPA | 2.4 | IPA | 2.4 |

### Example 2

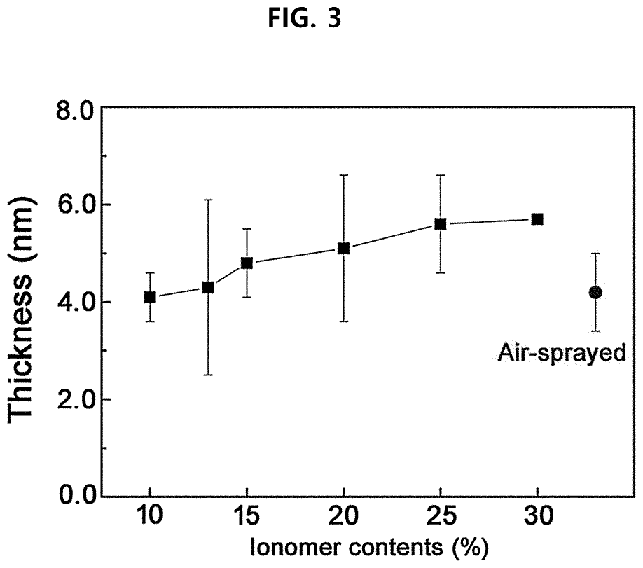

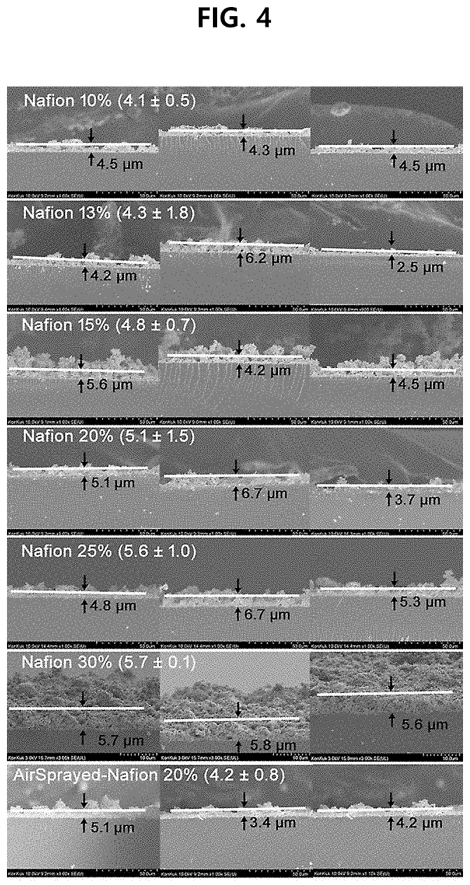

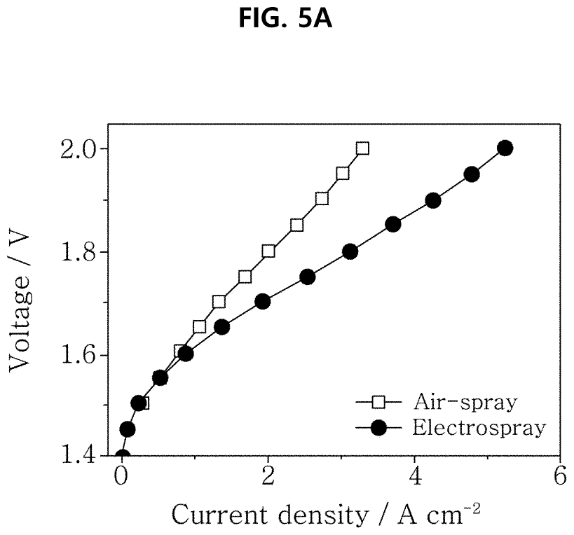

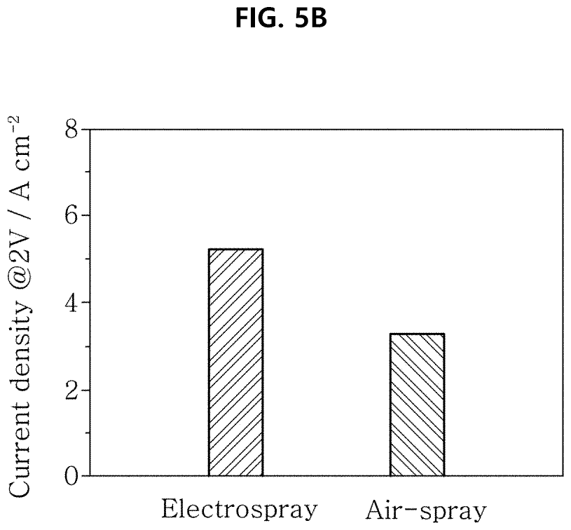

The electrode according to Example 1 was observed in terms of thickness, while the content of the ionomer was increased under the same catalyst content. Referring to FIG. 3 and FIGS. 5A and 5B, as the content of the ionomer is increased, the thickness of the electrode is increased.

Particularly, it can be seen that when the electrode is manufactured by using the same content of the ionomer, 20 wt %, the electrode (present example, black graph) obtained through electrospray shows a larger thickness as compared to the electrode (comparative, air-sprayed) obtained through air spray. It is thought that this is because a porous structure is formed through the electrostatic repulsion of catalyst particles.

### TEST EXAMPLES

### Test Example 1

Water electrolysis performance was evaluated at 80° C., after forming a unit cell for water electrolysis by using the membrane electrode assembly, a cathode diffusion layer (carbon paper) and an anode diffusion layer (titanium pelt). Before the evaluation, the unit cell was allowed to stand at 1.55 V for 30 minutes for the purpose of activation, after the cell temperature reached 80° C. Then, a voltage-current curve was obtained in a range of 1.4-2 V to determine the water electrolysis performance.

After comparing the electrodes with each other in terms of water electrolysis performance, it can be seen that the electrode using an electrospray process shows higher performance as compared to the electrode using a conventional air spray process, at a current density of 1 A/cm² or higher. This suggests that the electrode obtained by using electrospray shows improved water electrolysis performance. It is thought that this is because the effect of the formation of a porous structure through electrospray is limited at a low current density due to a small amount of gas generation, but the amount of gas generation is increased, as the current density is increased, and thus the effect of improving water electrolysis performance through the formation of a porous structure becomes prominent (FIGS. 5A and 5B).

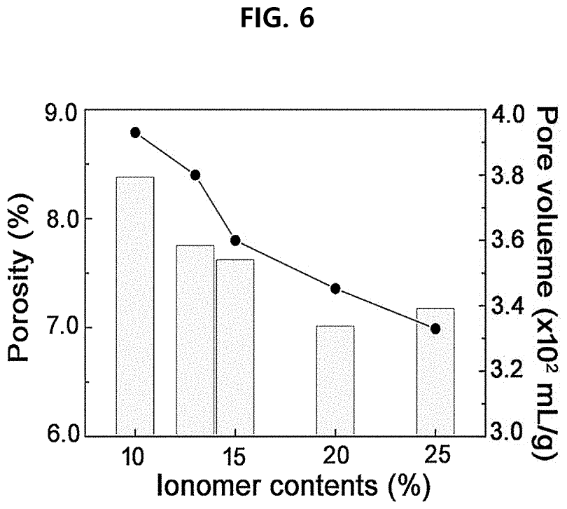

It can be seen that contact resistance and charge transfer resistance are reduced up to a content of ionomer of 13%, and then are increased from 10% (FIG. 6). It is thought that this is because excessively high porosity causes a decrease in conductivity in the electrode layer, resulting in an increase in contact resistance and overall resistance. It can be also seen that there is an optimized ionomer content for realizing low contact resistance and charge transfer resistance in the electrode obtained by using electrospray.

On the contrary, porosity is increased, as the ionomer content is reduced. Therefore, it can be seen that a suitable ionomer content providing high porosity, while minimizing contact resistance and charge transfer resistance, is required in order to obtain high water electrolysis performance.

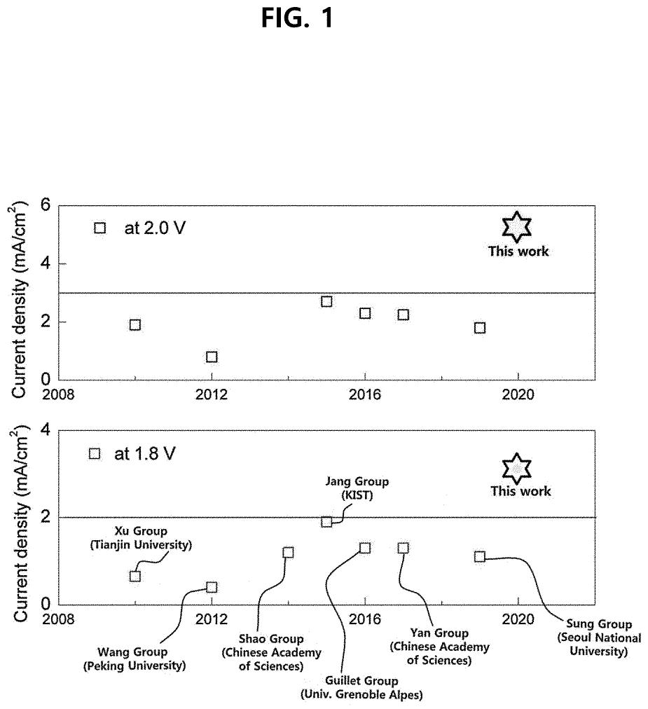

In addition, referring to FIG. 1 and the following Table 2, there is a significant difference in performance (current density) between membrane electrode assemblies at a high voltage (2.0 V) rather than a low voltage (1.8 V). This demonstrates that since a high current density generates a large amount of products and more frequent access of reactants to an electrode is required according to the reaction rate, such a large difference in current density between samples at a high voltage is an evidence of a significant effect of porosity upon water electrolysis performance.

TABLE 2

| | 2010 | 2012 | 2014 | 2015 | 2016 | 2017 | 2019 | 2020 |
|---|---|---|---|---|---|---|---|---|
| At 1.8 V | 0.65 | 0.4 | 1.2 | 1.9 | 1.3 | 1.3 | 1.1 | 3.1 |
| At 2.0 V | 1.9 | 0.8 | — | 2.7 | ~2.3 | ~2.25 | 1.8 | 5.3 |
| | Xu Group | Wang | Shao Group | Jang | Guillet | Yan | Sung | This |
| | (Tianjin | Group | (B. J. | Group | Group (P. | Group | Group | work |
| | University, | (Peking | Bladergroen | (KIST, | Millet | (CAS, | (SNU, | |
| | CHN) | University, | Group) (CAS, | KOR) | Group) | CHN) | KOR) | |
| | | CHN) | CHN) | | (Univ. | Chinese | | |
| | | | Chinese | | Grenoble | Academy | | |
| | | | Academy of | | Alpes, | of | | |
| | | | Sciences | | France) | Sciences | | |

L. Xu Group, International Journal of Hydrogen Energy, 35(2010) 3951-3957
C.-Y. Wang Group, J. Am. Chem. Soc. 2012, 134, 22, 9054-9057
J. H. Jang Group, Applied Catalysis B: Environmental, 179(2015)285-291
P. Millet Group, Applied Catalysis B: Environmental, 182(2016) 123-131
C. Yan Group, International Journal of Hydrogen Energy 42(2017) 26183-26191
Y.-E. Sung Group. Electrochimica Acta 295(2019)99-106
B. J. Bladergroen Group, International Journal of Hydrogen Energy, 38(2013) 9601-9608

1. An electrode for water electrolysis, comprising:
a substrate; and
a catalyst layer formed on the substrate through electrospray.

2. The electrode for water electrolysis according to claim 1, wherein the catalyst layer has a porosity of 5-20%.

3. The electrode for water electrolysis according to claim 1, wherein the electrode is an anode, and the catalyst layer comprises at least one of iridium oxide (IrO₂), ruthenium oxide and a carbon-supported platinum catalyst.

4. The electrode for water electrolysis according to claim 3, wherein the catalyst layer has a catalyst loading amount of 0.5-1.5 mg/cm².

5. The electrode for water electrolysis according to claim 1, wherein the electrode is a cathode, and the catalyst layer comprises at least one selected from the group consisting of an alloy (Ni, Co, Cr) based on a carbon-supported platinum catalyst, non-noble metal catalyst (Ni, Co, Cr, Mn), sulfide, nitride, phosphide and a heteroatom-doped carbon material.

6. The electrode for water electrolysis according to claim 5, wherein the catalyst layer has a catalyst loading amount of 0.3-1.3 mg/cm².

7. The electrode for water electrolysis according to claim 1, wherein the catalyst layer further comprises an ionomer.

8. A membrane electrode assembly for water electrolysis, comprising the electrode for water electrolysis according to claim 1.

9. A water electrolysis device comprising the electrode for water electrolysis according to claim 1.

10. A method for manufacturing the electrode for water electrolysis as defined in claim 1, comprising the steps of:
preparing a substrate; and
forming a catalyst layer on the substrate through electrospray.

11. The method for manufacturing the electrode for water electrolysis according to claim 10, wherein the electrospray is carried out at a voltage of 15-25 kV.

12. The method for manufacturing the electrode for water electrolysis according to claim 10, wherein the step of forming a catalyst layer on the substrate through electrospray is carried out by spraying a solution containing a catalyst, solvent and an ionomer through an electrospray process.

13. The method for manufacturing the electrode for water electrolysis according to claim 10, wherein the content of the ionomer is 5-30 wt % based on the total weight of the solution.
